(19) United States
(12) Patent Application Publication
(10) Pub. No.: US 2024/0070352 A1
(43) Pub. Date: Feb. 29, 2024

(54) SIMULATING ELECTRICAL GRID TRANSMISSION AND DISTRIBUTION USING MULTIPLE SIMULATORS

(71) Applicant: X Development LLC, Mountain View, CA (US)

(72) Inventors: Mike Miao He, Mountain View, CA (US); Hamed Khalilinia, San Mateo, CA (US); Sze Mei Cat Wong, Johns Creek, GA (US); Laura Elizabeth Fedoruk, Burlingame, CA (US); Leo Francis Casey, San Francisco, CA (US); Xinyue Li, San Mateo, CA (US)

(21) Appl. No.: 17/899,163

(22) Filed: Aug. 30, 2022

(51) Int. Cl. G06F 30/27

(52) U.S. Cl. CPC G06F 30/27

(57) ABSTRACT

Methods, systems, and apparatus, including medium-encoded computer program products, for selecting, from a unified electrical power grid model, a first proper subset of elements of the model. A first electrical grid simulation model is selected. A second, differing proper subset of elements of the model are selected. A second electrical grid simulation model that differs from the first electrical grid simulation model is selected. A set of boundary conditions common to the first electrical grid simulation model and the second electrical grid simulation model are determined. Operation of the electrical power grid is simulated, and can include (i) simulating, using the first electrical grid simulation model, the first proper subset of elements of the unified model, and the set of boundary conditions; and (ii) simulating, using the second electrical grid simulation model and the second proper subset of elements of the unified model, and the set of boundary conditions.

### TECHNICAL FIELD

This specification relates to techniques for simulating electrical power grid transmission and distribution, and more specifically, to simulating electrical power grid transmission and distribution using multiple subsets of a unified model of the electrical power grid.

### BACKGROUND

Electrical power grids are interconnected networks of power sources, power loads, and power delivery and regulating components. The delivery of electricity over a power grid can include transmission, which typically occurs at high voltage and over large distances, and distribution, which typically occurs at lower voltage and over shorter distances. For example, a power plant can generate electricity, which is then stepped up to high voltage for long distance transmission, and then stepped down at substations for low voltage distribution. The distribution system can then distribute power to local homes and businesses.

### SUMMARY

This specification relates to techniques for simulating electrical power grid transmission and distribution using multiple simulators that each perform simulations using a subset of the elements present in a unified model of the electrical power grid. Each subset can have boundary conditions that are used during a simulation.

Particular embodiments of the subject matter described in this specification can be implemented so as to realize one or more of the following advantages. The techniques described below can be used to accurately simulate the operation of an electrical grid that includes both transmission and distribution components, even when the characteristics of transmission can differ substantially from the characteristics of distribution. In addition, the techniques can be used to simulate grids even when various grid segments are operated by different entities. Further, the techniques reduce processing time and provide insights in data that would not otherwise be available to individual operators/dataset holders while maintaining data integrity and security.

One aspect features selecting, from a unified model of an electrical power grid, a first proper subset of elements of the unified model that correspond to a first proper subset of components of the electrical power grid for which the first electrical grid simulation model simulates operation. A first electrical grid simulation model that simulates operation of electrical power grid components is selected. A second proper subset of elements of the unified model are selected from the unified model of the electrical power grid, and correspond to the second proper subset of components of the electrical power grid for which the second electrical grid simulation model simulates operation. The second proper subset of elements can differ from the first proper subset of elements. A second electrical grid simulation model that differs from the first electrical grid simulation model is selected. The second electrical grid simulation model can simulate operation of electrical power grid components. From at least the first proper subset of elements and the second proper subset of elements of the unified model, a set of boundary conditions common to the first electrical grid simulation model and the second electrical grid simulation model are determined. Operation of the electrical power grid is simulated. The simulation can include: (i) simulating, using the first electrical grid simulation model, the first proper subset of elements of the unified model, and the set of boundary conditions, and operation of the first proper subset components of the electrical power grid to obtain a first set of operational values; and (ii) simulating, using the second electrical grid simulation model and the second proper subset of elements of the unified model, and the set of boundary conditions, operation of the second proper subset components of the electrical power grid to obtain a second set of operational values.

One or more of the following features can be included. The first proper subset of elements can include transmission elements. The first proper subset of elements can include distribution elements. The first proper subset of elements can include transmission elements and the second proper subset of elements can include distribution elements. Simulating operation can include processing an input comprising loads using a machine learning model that is configured to produce as output predicted loads the power grid. The boundary conditions can include intersections between elements in the first proper subset of elements of the unified model and the second proper subset of elements of the unified model. The boundary conditions can include conditions at one or more elements present in both the first proper subset of elements of the unified model and the second proper subset of elements of the unified model. Boundary conditions can be expressed as Boolean expressions. The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for simulating electrical grid transmission and distribution using multiple simulators.

FIG. 2A shows an example illustration of a grid model.

FIG. 2B shows an example illustration of grid models and simulation models.

FIG. 3 shows an example structure for a simulation environment, such as the environment 100 for simulating electrical grid transmission and distribution using multiple simulators

FIG. 4A is a flow diagram of an example process for simulating electrical grid transmission and distribution using multiple simulators.

FIG. 4B is a flow diagram of an example process for iteratively simulating electrical grid transmission and distribution using multiple simulators.

FIG. 5 is a block diagram of an example computer system.

### DETAILED DESCRIPTION

Electrical power grids include a broad range of interconnected components that can be organized into two broad categories: transmission components that deliver power from power generation along high voltage wires across long distances to substations, and distribution components that distribute power from substations to endpoints such as homes and businesses. Some elements, such as substations, participate in both transmission and distribution. The components can be of various types such as inverters (Solar, Wind, HVDC, etc.), relays, Power Plant Controllers (PPCs), Energy Management Systems, Remedial Action Systems (RAS), Automatic Generator Controls, alarm systems and so on.

The operation of one component often influences the operation of other components. For example, a PPC regulates and controls networked inverters within a power plant. In addition, various components can operate differently under different load conditions. Further, the output of one component can influence the load of other components. Understanding how the totality of components in the grid operate can aid in proper grid operation.

Interdependencies among components can be included in a unified grid model (or “grid model,” for brevity), which is a model that spans the totality of components from generators to end loads (e.g. households). A unified model can be a software representation of power system components and electrical networks that can include mathematical representations of the components used for simulation and analysis. Physical components of the electrical grid can be represented by elements of the grid model.

A unified grid model can be built using various data sources including topological data, geographical data, and characteristics of individual grid assets. Such data can be obtained from various data sources such as imagery and LIDAR measurements of actual grid components, sensor data (e.g., measurements obtained from actual grid operations), and utility data. Utility data can include information relating to various aspects of the electrical grid, including conductor types, poles and attachments, phase connections, among many other examples.

Simulations can be used to determine how various components will operate under such varying load conditions. The model used for simulation can be called an electrical grid simulation model (or “simulation model,” for brevity), which can operate on a unified grid model or on a subset of a unified grid model.

However, some electric grid simulators have difficulty simulating both transmission and distribution networks within the unified grid model of the electric grid. For example, transmission simulations generally assume balanced 3-phase transmission lines, balanced loads, and balanced sources. Such assumptions are not necessarily true for distribution networks. The types of equipment and components in transmission and distribution networks can also differ. Further, various segments of the power grid can be operated by different parties, each of which can be interested only in a subset of grid components. Accordingly, the system and methods described below facilitate the generation of separate models from a unified model, and simulate the models in separate manners such that their boundary conditions are consistent. In this way, the need for redesigning or generating a new, singular model for simulation software that does not perform adequately using a unified model is avoided.

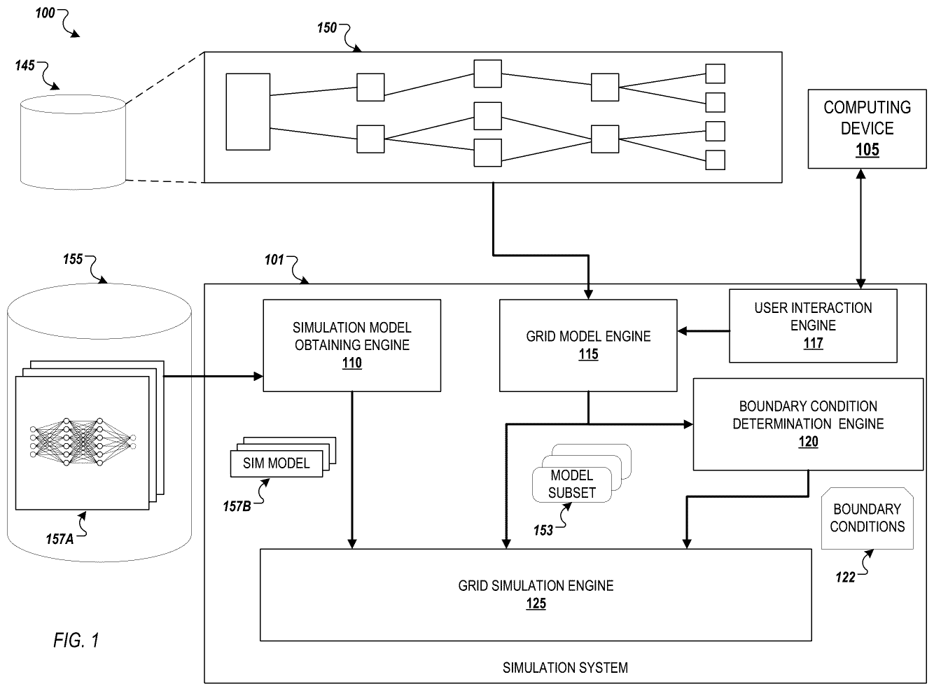

FIG. 1 shows an example of an environment 100 for simulating electrical grid transmission and distribution using multiple simulators. The environment can include a simulation system 101, one or more electrical grid simulation models 157A, 157B and a unified model of an electrical power grid 150 (“grid model,” for brevity).

A grid model 150 can include elements that represent the components of an electrical grid and interconnections among the elements. As described above, the components can include inverters, relays, PPCs, Energy Management Systems, RASs, Automatic Generator Controls, alarm systems and so on. In addition, components can include other elements relevant to the transmission and distribution of power, such as transmission towers and utility poles. Elements in the grid model can include references to descriptive information about the components that can include various metadata, such as a unique element identifier for an element, information about the component represented by the element such as make, model, deployment date, damage reports, photographs, service history, role of the element and so on. A role can include whether the element is used for transmission or distribution, or both. The descriptive information can further include information about the environment at or around components, such as temperature and humidity measured at various times. The grid model 150 can further include descriptions of components that connect components, such as power lines. For such connection components, the grid model can include a description of the components connected by the connection component, and a description of the connection component that connects.

Elements of a grid model 150 can have associated operating conditions that specify constraints on operation of the component. For example, an operating condition can indicate that the temperature at the component cannot exceed a maximum value or that the voltage at a component must remain within a given range. Operating conditions can be expressed as Boolean expressions and can be associated with an element representing a component.

The grid model 150 can include references to one or more simulation models 157 that apply to the grid model 150. In some implementations, each element of the simulation model 157 includes a reference to a simulation model 157 for that element. In some implementations, a simulation model 157 can apply to a subset, or “region,” of the simulation model 150. The grid model repository 145 (described below) can include associations between the entire grid model, elements of the grid model or regions of a grid model, and the corresponding simulation models 157. When simulation models 157 apply to a region that consists of more than one element, each element in the region can include a reference to the simulation model.

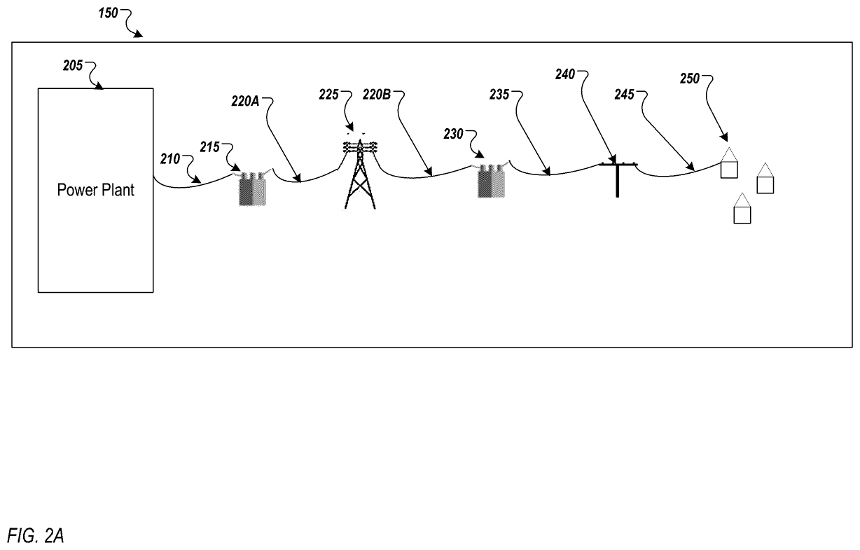

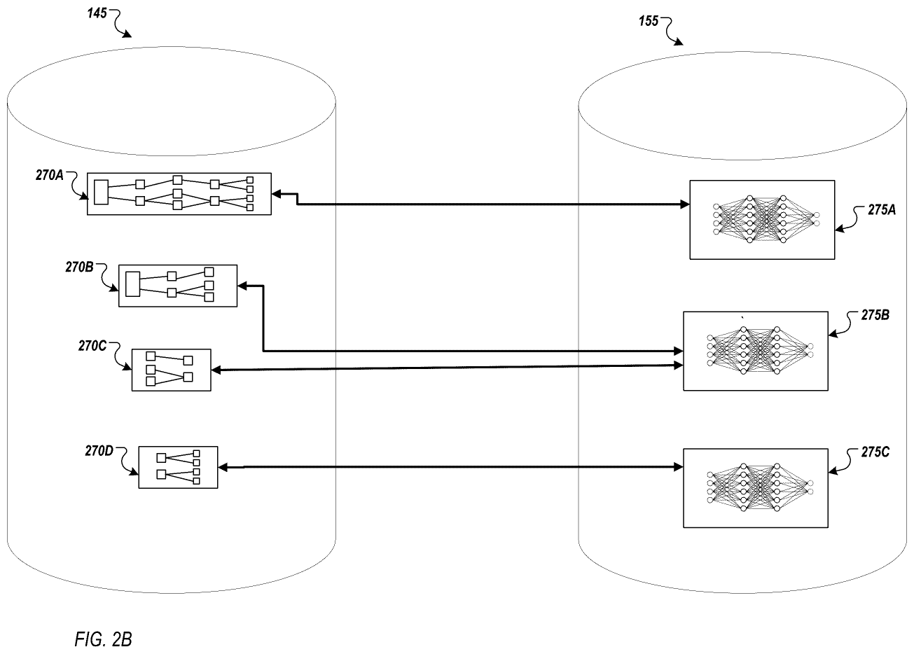

FIG. 2A shows an example illustration of a grid model 150. In this example, the grid model contains a power plant 205 that is connected by a high voltage power line 210 to a distribution substation 215. The voltage of the output from the power plant 205 is stepped up for transmission on the high voltage power line 210. The distribution substation 215 is connected to a second substation 230 by high voltage power lines 220A, 220B that span a transmission tower 225. The second substation 230 can include a transformer that reduces voltage before delivering electricity across lower voltage power lines 235, 245 that span utility poles 245 and are connected to end points 250 such as homes, apartments, businesses, etc.

Returning to FIG. 1, simulation models 157A, 157B (collectively referred to as simulation models 157) can include a description of how elements in a grid region (which can be an entire grid or a subset of a grid) are predicted to behave under various electrical conditions, where an electrical condition can include various loads and other conditions (e.g., weather conditions). In some implementations, simulation models 157 can include one or more functions that can accept as input loads and conditions and can produce predicted loads at the elements within and at the boundaries of the portion of the grid being simulated. In some implementations, simulation models 157 can be machine learning models, such as neural networks, configured to accept as input loads and conditions and to produce as output predicted load within and at the boundaries of the portion of the grid being simulated. Other forms of grid models, including computer code can be used, and various forms of computer simulations (functions, neural networks, computer code, etc.) can be used in combination.

Such simulation models 157 can accept as input simulated loads at the boundary of the grid region, and can produce predictions that can include (i) predicted loads at one or more of the components within the grid region, (ii) predicted loads at the boundary of the region, or (iii) both predicted loads at the components within the grid region and predicted loads at the boundary of the region.

The simulation models 157 can apply to an entire grid region, or to a portion of a grid region. In implementations in which a simulation model 157 applies to an entire grid region, the simulation model 157 can accept as inputs and produce outputs for the entire grid region. In some implementations, multiple simulation models 157 apply to the elements in a grid region. For example, each element within a grid region can have an associated simulation model 157, and the simulation can be performed by simulating each element with the grid region. In another example, multiple sub-region within a grid region can have associated simulation models 157, and the simulation can be performed by simulating each sub-region with the grid region.

FIG. 2B show an example illustration of grid models and simulation models. In this example, grid model 270A references simulation model 275A, grid models 270B and 270B reference simulation model 275B, and grid model 270D references simulation model 275C (grid models 270B-D can be proper subsets of the unified grid model 270A, or can themselves be unified grid models of different grids.). The grid models 270A, 270B, 270C, 270D can be stored in the grid model repository 145, and the simulation models 275A, 275B, 275C can be stored in the simulation model repository 155. In some implementations, the references can be names, e.g., a simulation model is assigned a unique name, and a grid model includes a reference to that unique name. In some implementations, the simulation models 275A, 275B, 275C each contain references to the grid models 270A, 270B, 270C, 270D that use them, as illustrated by the arrows pointing from the simulation models 275A, 275B, 275C to the grid models 270A, 270B, 270C, 270D.

Returning to FIG. 1, the simulation system 101 can include a simulation model obtaining engine 110, a grid engine 115, a boundary condition determination engine 120 and a grid simulation engine 125. In some implementations, the simulation system 101 can include a user interaction engine 117 that can provide user interface presentation data to computing devices 105 such as personal computer, laptops, smart phones and tablet computer. When rendered by the computing device 105, the user interface presentation data can enable a user to provide information to the user interaction engine 117 that can be used by the simulation system 101. For example, the user interaction engine 117 can provide descriptions of grid model subsets 153 (described further below) to the grid model engine 115.

In some implementations, the grid model engine 115 can obtain a grid model 150 and provide grid model subsets 153 to the boundary condition determination engine 120 and to the grid simulation engine 125. In some implementations, the grid model engine 115 can obtain grid model subsets 153 of a grid model 150, and provide those grid model subsets 153 to the boundary condition determination engine 120 and to the grid simulation engine 125.

A grid model subset 153 can be a proper subset of a grid model 150, and can include elements and connections among the elements. For example, in FIG. 2, a grid model subset 153 could include elements 205, 210 215, 220A, 225, 220B and 230 and a second model subset 152 could include elements 230, 235, 240, 245 and 250. A grid model subset 153 can represent a functional subset of a grid model. For example, one grid model subset 153 can include transmission elements and a second grid model subset 153 can include distribution elements. In another example, one grid model subset 153 can include elements operated by one entity (e.g., a power company), and a second grid model subset 153 can include elements operated by a different entity. The grid model subsets 153 are derived from the extant unified grid model 150.

The grid model engine 115 can obtain a grid model 150 or grid model subsets 153 from one or more grid model repositories 145. A grid model repository 145 can be any conventional data repository such as a relational database or a file system. The grid model engine can obtain a grid model 150 or grid model subsets 153 using techniques suitable for the data repository, such as structured query language (SQL) operations to retrieve data from a relational database or file system operations provided by an operating system to retrieve models from a file system. The grid model engine 115 can determine grid model subsets 153 from a grid model 150 or from a grid model subset 153, as described further below.

The boundary condition determination engine 120 can accept grid model subsets 153 and determine boundary conditions 122 between the grid model subsets 153. Boundary conditions 122 can represent intersections between elements of one grid model subset 153 and a second grid model subset 153. In the example given above where a first grid model subset 153 includes elements 205, 210 215, 220A, 225, 220B and 230 and a second model subset 152 includes elements 230, 235, 240, 245 and 250, element 230 represents a boundary condition as it exists in both grid model subsets 153. Boundary conditions can include both overlapping elements (e.g., the same elements that are in each grid model, or elements that are directly coupled to each other in the grid models, such as conductors on either side of a transformer) and conditions that must exist at the elements (e.g., same voltage, same current, or same power).

A condition can be specified as a Boolean expression that must evaluate to TRUE. For example, a boundary condition can specify that in element 230 in both grid model subsets the voltage must be the same. In another example, a boundary condition can specify that a property (e.g., a voltage) must be within a specified range for each element subject to the boundary condition. A boundary condition can be an operating condition, as described above.

The simulation model obtaining engine 110 can obtain simulation models 157A, 157B from a simulation model repository 145. A simulation model repository 155 can be any conventional data repository such as a relational database or a file system. The simulation model obtaining engine 110 can obtain simulation models 157 using techniques suitable for the data repository, such as structured query language (SQL) operations to retrieve data from a relational database or file system operations provided by an operating system to retrieve models from a file system. The simulation model obtaining engine 110 can provide simulation models 157 to the grid simulation engine 125.

The grid simulation engine 125 can accept simulation models 157, grid model subsets 153 and boundary conditions 122 and provide predicted operational values such as voltage and current. The grid simulation engine 125 can execute simulation models 157 on the grid model subsets 153 and using the boundary conditions 122 as constraints.

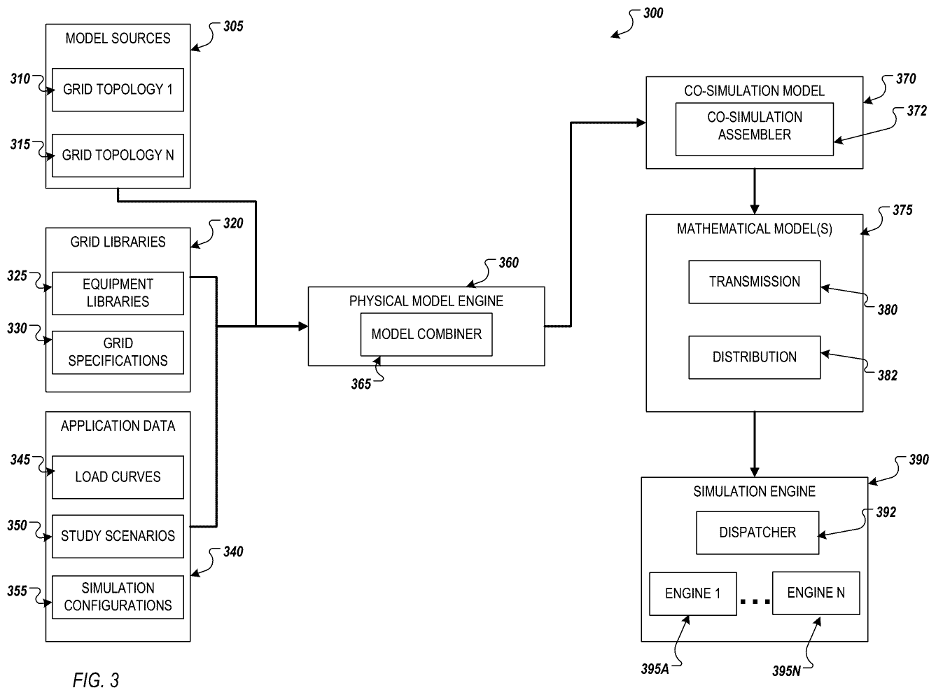

FIG. 3 shows an example structure 300 for a simulation environment, such as the environment 100 for simulating electrical grid transmission and distribution using multiple simulators of FIG. 1. The structure can include model sources 305, grid libraries 320, application data 340, a physical model engine 340, a co-simulation model, mathematical models 375 and a simulation engine 390.

The model sources 305, grid libraries 320 and application data 340 can define the unified grid model. The model sources 305 can include grid topologies 310, 315 that define regions within an overall grid, and can (but need not) correspond with grid model subsets. The grid libraries 320 can include metadata about elements in the unified grid model and can include equipment libraries 325 and grid specifications 330. Application data 340 can include load curves 345 that can be based on historical observations, study scenarios 350 that can include data observed under studied conditions and simulation configurations 355. Simulation configurations 355 can include start/stop time, time step size, solver type and error tolerance, the maximum number of iterations, data recorder and sampling rate and unit, and so on.

The physical model engine 360 can include a model combiner 365 that obtains information from the model sources 305, grid libraries 320 and application data 350 to create a physical model of the system. The co-simulation model 370 can include a co-simulation assembler, which derives simulations based on the combined model 360. The co-simulation module 270 determines when and which simulation to run based on user study configuration. For example, in a first time interval from t₀ to t₁, run a steady state simulation, and in a second time interval from t₁ to t₂ run a transient simulation, where the steady state simulation state at t₁ is used (e.g., linked) to initialize the transient simulation.

Mathematical models 375 can include various types of models such as transmission models 380 and distribution models 382. The transmission models 380 can simulate delivery along the high voltage lines, and the distribution models 382 can simulate delivery along low voltage lines. Transmission models 380 can: (i) represent power lines, transformers, and other transmission equipment; (ii) assume balanced, positive-sequence voltages and currents, and (iii) include parameters such as impedances and phase connections appropriate for the transmission models 380. Distribution models 282 can: (i) incorporate full three-phase representation of power lines, transformers, and other distribution equipment, and (ii) incorporate full parameter information on a per phase basis and including full symmetrical component values. Transmission models 380 and distribution models 382 can include different elements. For example, transmission models 380 can include components such as large synchronous generators and their dynamics and high voltage transformers, whereas distribution models 382 can include components such as distributed resources and small-scale inverter-based resources.

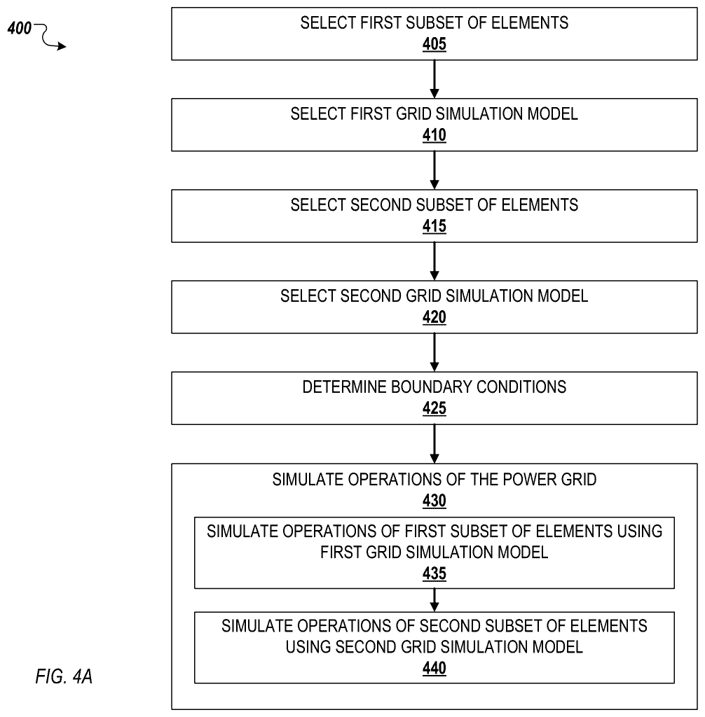

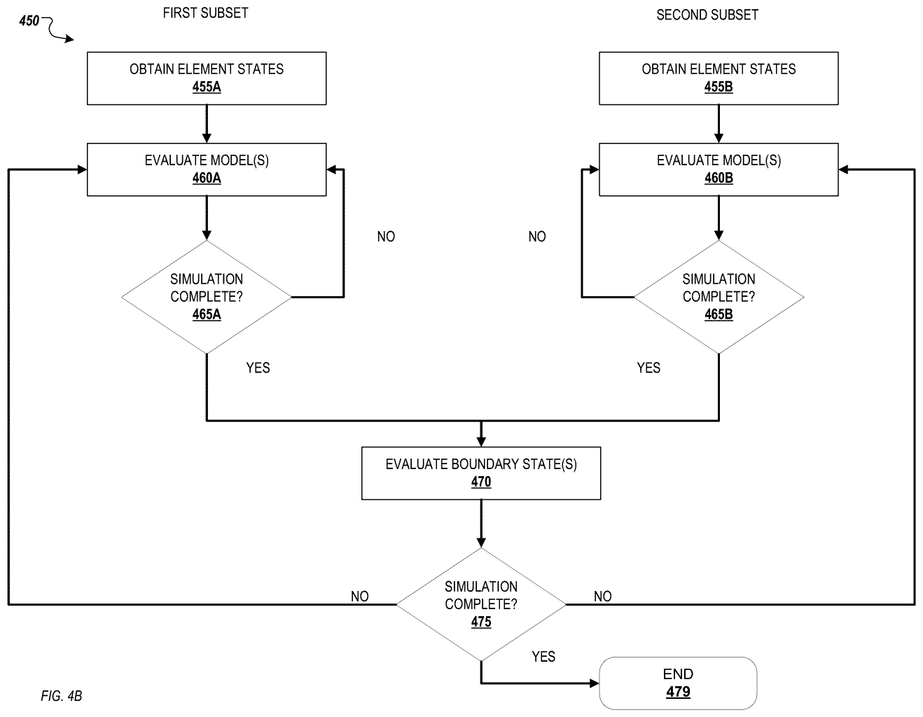

The simulation engine 390 can include a dispatcher 392 and one or more simulation engine 395A, 395N (collectively referred to as simulation engines 395). The dispatcher 392 can assign simulations to the simulation engines 395 for execution. Simulation engines 395 are described in further detail in reference to FIGS. 4A and 4B.

FIG. 4A is a flow diagram of an example process for simulating electrical grid transmission and distribution using multiple simulators. For convenience, the process 400 will be described as being performed by a simulation system, e.g., the simulation system 101 of FIG. 1, appropriately programmed to perform the process. Operations of the process 400 can also be implemented as instructions stored on one or more computer readable media which may be non-transitory, and execution of the instructions by one or more data processing apparatus can cause the one or more data processing apparatus to perform the operations of the process 400. One or more other components described herein can perform the operations of the process 400.

The system selects (405) from a unified model of an electrical power grid, a first proper subset of elements of the unified model that correspond to a first proper subset of components of the electrical power grid for which the first electrical grid simulation model simulates operation. The system can select the proper subset of elements (“model subset,” for brevity) using various techniques. In some implementations, the system selects the model subset from a model repository. The system can obtain a specification of the model subset (e.g., by reading it from a storage device) and use the specification to obtain the model subset from the repository. In some implementations, the specification can be a reference to a model subset such as the name of the model subset, and use the name of the model subset to obtain the model subset from the repository. In some implementations, the system can obtain the specification model subset from a user, e.g., from a user providing the specification by interacting with user interface presentation data provided to the user by the system. In other implementations, the subset can be determined from a specification of a the elements to be simulated based on the element metadata, e.g., for a particular substation and its loads, the substation is specified and all elements that correspond to the substation and its loads are selected from the unified model).

In some implementations, the system can obtain a unified model from a data repository, e.g., by reading the specification from a file system using file system operations provided by an operating system associated with the file system, and select a first model subset from the unified model. In some implementations, the system can obtain a specification of the model subset from a user, e.g., from a user who provides the specification by interacting with user interface presentation data provided to the user by the system. The specification can include a list of elements of the unified model to be included in the model subset. The system can use the list of elements to identify the elements of the unified model to include in the model subset.

The system selects (410) a first electrical grid simulation model that simulates operation of electrical power grid components. In some implementations, the system retrieves a simulation model from a simulation model repository, e.g., by issuing SQL commands to the simulation model repository. As described above, grid models can include references to simulation models, and the system can use the reference from the grid model to retrieve the simulation model. If the reference is a unique identifier for a simulation model, the system can use the unique identifier to retrieve the simulation model from the simulation repository. For example, the system can determine the identifier from the grid model, and include the identifier in an SQL query to a relational database that contains simulation models. In response, the system can receive the simulation model from the database.

The system selects (415) from the unified model of the electrical power grid, a second proper subset of elements of the unified model that correspond to the second proper subset components of the electrical power grid for which the second electrical grid simulation model simulates operation, wherein the second proper subset of elements differs from the first proper subset of elements. The system can select the second proper subset using the operation described in reference to 405 or similar operations.

The system selects (420) a second electrical grid simulation model that differs from the first electrical grid simulation model and that simulates operation of electrical power grid components. The system can select the second electrical grid simulation model using the operation described in reference to 410 or similar operations.

The system determines (425), from at least the first proper subset of elements and the second proper subset of elements of the unified model, a set of boundary conditions common to the first electrical grid simulation model and the second electrical grid simulation model. To determine boundary conditions, the system can first determine elements that are common to both the first and second subset of the unified model, then determine the boundary conditions at those elements. As noted above, each element of the unified grid model can include a unique element identifier, and the system can determine elements that are common to both subsets by matching element identifiers. For example, for each element in the first subset, the system can determine the element identifier, then compare the element identifier to the element identifier for each element in the second subset. If the element identifiers match, the system can determine that the elements are common to both subsets. The system can then determine boundary conditions by determining the operating conditions associated with each element (as described in reference to FIG. 1) identified as common to both subsets.

The system simulates (430) operation of the electrical power grid. The simulation can include simulating (435), using the first electrical grid simulation model, the first proper subset of elements of the unified model, and the set of boundary conditions, operation of the first proper subset components of the electrical power grid to obtain a first set of operational values. The simulation can further include simulating (440), using the second electrical grid simulation model and the second proper subset of elements of the unified model, and the set of boundary conditions, operation of the second proper subset components of the electrical power grid to obtain a second set of operational values.

In some implementations, the system performs each of the two simulations iteratively. FIG. 4B is a flow diagram of an example process for iteratively simulating electrical grid transmission and distribution using multiple simulators. For convenience, the process 450 will be described as being performed by a simulation system, e.g., the simulation system 101 of FIG. 1, appropriately programmed to perform the process. Operations of the process 450 can also be implemented as instructions stored on one or more computer readable media which may be non-transitory, and execution of the instructions by one or more data processing apparatus can cause the one or more data processing apparatus to perform the operations of the process 450. One or more other components described herein can perform the operations of the process 450.

The system obtains (455A, 445B) the initial state of the elements in each grid subset, including the boundary elements. As noted above, each subset can include grid regions, and each grid region can have a simulator. In such cases, each grid region is treated as if it were a single element with an initial state, inputs and outputs. The initial state can include the load on the elements.

The system can obtain the state using various techniques. In some implementations, the system can read the initial state from a repository. For example, if the repository is a file system, the system can read the initial state using conventional file system operations. In another example, if the repository is a relational database, the system can use SQL operations to obtain the initial state.

In some implementations, the system can obtain the initial state by generating values. For example, if the simulation is intended to predict grid operation under certain conditions that are defined by simulation parameters (e.g., a 1%, 3% or 5% increase over a measured load), the system can obtain current load values (e.g., from a database), and scale current load values according to the simulation parameters. In another example, the system can generate initial values by generating random simulated loads, where the random value can be limited by constraints defined by simulation parameters. For example, simulation parameters can specify that the initial simulated load can vary by a certain percentage (e.g., 5%, 10%, 15%) from an actual initial load. The system can generate random or pseudo-random initial loads according to the simulation parameters.

At each iteration, the system evaluates (460A, 460B) the simulation model(s) for both subsets using the initial state of the elements. As noted above, the grid simulators can take various forms, including neural networks, program code and mathematical formulas. The system evaluates the models using the appropriate evaluation technique. For example, for a model that includes program code, the system executes the program code using the element states and the boundary conditions to produce updated values at each element. In another example, for a model that includes a neural network, the system uses the neural network to process an input that includes the state of the elements and the boundary conditions. The result of processing the model is a new state for the elements.

The system determines (465A, 465B) whether the simulation of each subset is complete. The system can iterate the simulations for each model subset until termination criteria are satisfied. In some implementations, the termination criteria can include a configured number of iterations. In some implementations, the termination criteria can include stability criteria. Stability criteria can be satisfied when changes to the state of the elements is below a configured threshold. The termination criteria for each model subset are not required to be the same. The system can evaluate the termination criteria to determine whether the criteria are satisfied. If the criteria for a model subset are satisfied, the system can proceed to the corresponding operation 470A, 470B; if the criteria are not satisfied for a model subset, the system can continue the corresponding simulation (operations 465A, 465B). In some simulations, the system can determine that each model satisfies the termination criteria after a different number of iterations.

The system evaluates (470) boundary states. As noted previously, since boundary states represent the state of elements that are common in both model subsets, the states at such elements must satisfy alignment criteria. For example, alignment criteria might specify that the states are the same or that the states are within a configured tolerance (e.g., the states vary by no more than 0.1%, 0.5%, etc.).

The system determines (475) whether the overall simulation is complete. If the boundary states satisfy the alignment criteria, the system can determine that the simulation is complete and end (479) the simulation. If the system determines that the alignment criteria are not satisfied, the system can reevaluate the models and adjust the models accordingly (460A, 460B).

Returning to FIG. 4A, in some implementations, the system first selects (410, 420) electrical grid simulation models, then selects (405, 415) from a unified model of an electrical power grid, first and second proper subset of elements of the unified model. The system can select (410, 420) a simulation model, the select (405, 415) a subset of elements to which the model applies. As illustrated in FIG. 2B, simulation models 275A-C can include references to subsets 270A-D of the unified grid models to which the simulation applies. The system can use the reference from the simulation model to the grid model(s) to select the subset of elements to which the simulation model applies.

In some implementations, a simulation model applies only to a portion of a model subset. In such cases, to simulate the entire model subset, the system can select multiple simulation models until the portions of the model subset span the entire model subset. The system can create a list of elements in a model subset, select a simulation model, determine the portion of the model subset covered by the simulation model, and remove those elements from the list of elements. The system can continue selecting simulation models until all elements have been removed from the list of elements, indicating that all elements are simulated by at least one simulation model. The system can treat elements that are present in multiple portions as boundary elements between those portions.

In some implementations, the system can perform the selection of grid model subsets and simulations in various combinations. For example, the system can first select a simulation model, then determine the portion of a grid subset covered by that simulation model. The system can then select one of the remaining elements (i.e., an element not covered by the selected simulation model) and determine a second simulation model using the reference from the element to the corresponding simulation model (e.g., as shown FIG. 2B).

Once selected, the system can evaluate the simulation model using the operations 450 of FIG. 4B or similar operations. Note that while FIG. 4B illustrates co-execution of two models (operations 455A, 460A, 465A and operations 455B, 460B, 465B), the system can co-execute any number of models. The results of the co-execution of models within a first subset of the unified model can be combined with the results of the co-execution of models within a second subset of the unified model. That is, the system can perform simulations of the first proper subset and/or the second proper subset piecewise, and combine the results similarly to how the first and second proper subsets are simulated separately then combined.

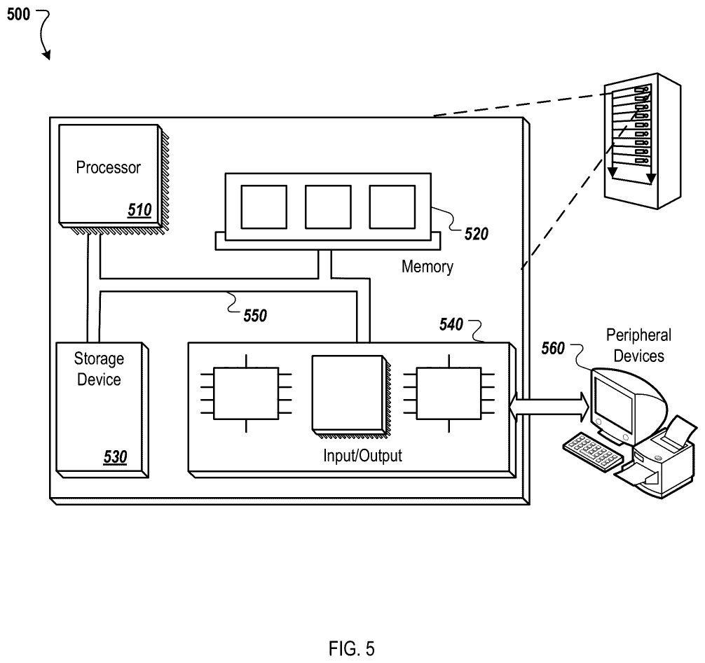

FIG. 5 is a block diagram of an example computer system 500 that can be used to perform operations described above. The system 500 may be one of many servers or allocated workers in a cloud system. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
selecting, from a unified model of an electrical power grid, a first proper subset of elements of the unified model that correspond to a first proper subset of components of the electrical power grid for which the first electrical grid simulation model simulates operation;
selecting a first electrical grid simulation model that simulates operation of electrical power grid components;
selecting, from the unified model of the electrical power grid, a second proper subset of elements of the unified model that correspond to the second proper subset components of the electrical power grid for which the second electrical grid simulation model simulates operation, wherein the second proper subset of elements differs from the first proper subset of elements;
selecting a second electrical grid simulation model that differs from the first electrical grid simulation model and that simulates operation of electrical power grid components;
determining, from at least the first proper subset of elements and the second proper subset of elements of the unified model, a set of boundary conditions common to the first electrical grid simulation model and the second electrical grid simulation model;
simulating operation of the electrical power grid, the simulating comprising:
simulating, using the first electrical grid simulation model, the first proper subset of elements of the unified model, and the set of boundary conditions, and operation of the first proper subset components of the electrical power grid to obtain a first set of operational values; and
simulating, using the second electrical grid simulation model and the second proper subset of elements of the unified model, and the set of boundary conditions, operation of the second proper subset components of the electrical power grid to obtain a second set of operational values.

2. The computer-implemented method of claim 1 wherein the first proper subset of elements comprise transmission elements.

3. The computer-implemented method of claim 1 wherein the first proper subset of elements comprise distribution elements.

4. The computer-implemented method of claim 1 wherein the first proper subset of elements comprise transmission elements and the second proper subset of elements comprise distribution elements.

5. The computer-implemented method of claim 1 wherein simulating operation comprises processing an input comprising loads using a machine learning model that is configured to produce as output predicted loads the power grid.

6. The computer-implemented method of claim 1 wherein the boundary conditions comprise intersections between elements in the first proper subset of elements of the unified model and the second proper subset of elements of the unified model.

7. The computer-implemented method of claim 1 wherein boundary conditions comprise conditions at one or more elements present in both the first proper subset of elements of the unified model and the second proper subset of elements of the unified model.

8. The computer-implemented method of claim 1 wherein boundary conditions are expressed as Boolean expressions.

9. A system comprising one or more computers and one or more storage devices storing instructions that when executed by the one or more computers cause the one or more computers to perform operations comprising:
selecting, from a unified model of an electrical power grid, a first proper subset of elements of the unified model that correspond to a first proper subset of components of the electrical power grid for which the first electrical grid simulation model simulates operation;
selecting a first electrical grid simulation model that simulates operation of electrical power grid components;
selecting, from the unified model of the electrical power grid, a second proper subset of elements of the unified model that correspond to the second proper subset components of the electrical power grid for which the second electrical grid simulation model simulates operation, wherein the second proper subset of elements differs from the first proper subset of elements;
selecting a second electrical grid simulation model that differs from the first electrical grid simulation model and that simulates operation of electrical power grid components;
determining, from at least the first proper subset of elements and the second proper subset of elements of the unified model, a set of boundary conditions common to the first electrical grid simulation model and the second electrical grid simulation model;
simulating operation of the electrical power grid, the simulating comprising:
simulating, using the first electrical grid simulation model, the first proper subset of elements of the unified model, and the set of boundary conditions, and operation of the first proper subset components of the electrical power grid to obtain a first set of operational values; and
simulating, using the second electrical grid simulation model and the second proper subset of elements of the unified model, and the set of boundary conditions, operation of the second proper subset components of the electrical power grid to obtain a second set of operational values.

10. The system of claim 9 wherein the first proper subset of elements comprise transmission elements.

11. The system of claim 9 wherein the first proper subset of elements comprise distribution elements.

12. The system of claim 9 wherein the first proper subset of elements comprise transmission elements and the second proper subset of elements comprise distribution elements.

13. The system of claim 9 wherein simulating operation comprises processing an input comprising loads using a machine learning model that is configured to produce as output predicted loads the power grid.

14. The system of claim 9 wherein the boundary conditions comprise intersections between elements in the first proper subset of elements of the unified model and the second proper subset of elements of the unified model.

15. The system of claim 9 wherein boundary conditions comprise conditions at one or more elements present in both the first proper subset of elements of the unified model and the second proper subset of elements of the unified model.

16. The system of claim 9 wherein boundary conditions are expressed as Boolean expressions.

17. One or more non-transitory computer-readable storage media storing instructions that when executed by one or more computers cause the one or more computers to perform operations comprising:
selecting, from a unified model of an electrical power grid, a first proper subset of elements of the unified model that correspond to a first proper subset of components of the electrical power grid for which the first electrical grid simulation model simulates operation;
selecting a first electrical grid simulation model that simulates operation of electrical power grid components;
selecting, from the unified model of the electrical power grid, a second proper subset of elements of the unified model that correspond to the second proper subset components of the electrical power grid for which the second electrical grid simulation model simulates operation, wherein the second proper subset of elements differs from the first proper subset of elements;
selecting a second electrical grid simulation model that differs from the first electrical grid simulation model and that simulates operation of electrical power grid components;
determining, from at least the first proper subset of elements and the second proper subset of elements of the unified model, a set of boundary conditions common to the first electrical grid simulation model and the second electrical grid simulation model;
simulating operation of the electrical power grid, the simulating comprising:
simulating, using the first electrical grid simulation model, the first proper subset of elements of the unified model, and the set of boundary conditions, and operation of the first proper subset components of the electrical power grid to obtain a first set of operational values; and
simulating, using the second electrical grid simulation model and the second proper subset of elements of the unified model, and the set of boundary conditions, operation of the second proper subset components of the electrical power grid to obtain a second set of operational values.

18. The one or more non-transitory computer-readable storage media of claim 17 wherein the first proper subset of elements comprise transmission elements and the second proper subset of elements comprise distribution elements.

19. The one or more non-transitory computer-readable storage media of claim 17 wherein simulating operation comprises processing an input comprising loads using a machine learning model that is configured to produce as output predicted loads the power grid.

20. The one or more non-transitory computer-readable storage media of claim 17 wherein the boundary conditions comprise intersections between elements in the first proper subset of elements of the unified model and the second proper subset of elements of the unified model.
